(19) United States
(12) Patent Application Publication
(10) Pub. No.: US 2014/0272905 A1
(43) Pub. Date: Sep. 18, 2014

(54) ADAPTIVE LEARNING SYSTEMS AND ASSOCIATED PROCESSES

(71) Applicant: ADAPT COURSEWARE, Pittsford, NY (US)

(72) Inventor: John R. Boersma, Pittsford, NY (US)

(21) Appl. No.: 13/837,424

(22) Filed: Mar. 15, 2013

(51) Int. Cl. G09B 7/00

(52) U.S. Cl. CPC G09B 7/00
USPC 434/362

(57) ABSTRACT

Adaptive learning systems and process are described herein for providing an online learning environment for delivering a course comprising a plurality of learning activities having different levels of difficulty to a user in a manner that supports user motivation. The systems and processes described herein dynamically adapt the selection of learning activities to display to the user to find/maintain a personally selected challenge for the user. Learning activities require user input and can be used to test a user's proficiency of the corresponding subject matter. The system can also support user motivation by affording a user multiple opportunities to correctly complete a learning activity as well as providing hints to the user to increase the user's chance of successfully completing a learning activity on a subsequent attempt.

### BACKGROUND OF THE INVENTION

In an ever more electronically integrated world, more and more activities are performed in a networked environment to improve efficiencies. As part of this process, educational activities are also being moved to a growing degree to an automated electronic environment. One factor in effective instruction delivery is the motivation of the student/system user. Another factor is maintaining the attention of the student user without a set of human eyes watching or the sound of a human voice working to hold the student's attention.

In a networked environment, a student user of an automated educational system can be in a central location on an educational campus or potentially across the world. Potential efficiency improvements can follow from a reduction of teachers per student, although personnel interaction can instead be integrated into the system through personal, video, voice and/or e-mail communication with an instructor to provide for answering questions, provide motivation or just to check in.

### SUMMARY OF THE INVENTION

In a first aspect, the invention pertains to a computing device comprising a processor, a display device, and an accessible storage medium having instruction thereon which, when executed by the processor, cause the computing device to perform a method for dynamically selecting a learning activity to deliver to a user to support user motivation. The method comprises selecting a learning activity having a difficulty level from a database comprising a plurality of learning activities and associated difficulty levels, the learning activities logically associated into groups in the database wherein each group corresponds to a section of a course, and displaying the learning activity to a user via the display device, wherein a learning activity comprises a challenge and one or more user input fields configured to receive input collectively indicating completion of the learning activity and wherein the difficulty level is a measure of the probability that the user will successfully complete the learning activity; wherein the computing device previously displayed to a user M times, a previous learning activity having a previous difficulty level selected from database and wherein each time the computing device previously displayed the previous learning activity, the user attempted to successfully complete the previous learning activity, wherein M≦N with N being a selected limiting value of M, wherein M and N are integers greater than or equal to 1 and wherein the learning activity and the previous learning activity are associated with the same group in the database; wherein the difficulty level is less than the previous difficulty level if the user did not successfully complete the previous learning activity within N attempts; wherein the difficulty level is greater than the previous difficulty level if the user successfully completed the previous learning activity after M attempts; and wherein the learning activity has not been previously successfully completed by the user.

In a second aspect, the invention pertains to a method, implemented on computing device comprising a processor, a display device and accessible memory, for dynamically selecting a learning activity to deliver to a user to support user motivation. The method comprises selecting a learning activity having a difficulty level from a database comprising a plurality of learning activities and associated difficulty levels, the learning activities logically associated into groups in the database wherein each group corresponds to a section of a course, and displaying the learning activity to a user via the display device, wherein a learning activity comprises a challenge and one or more user input fields configured to receive input collectively indicating completion of the learning activity and wherein the difficulty level is a measure of the probability that the user will successfully complete the learning activity; wherein the computing device previously displayed to a user M times, a previous learning activity having a previous difficulty level selected from database and wherein each time the computing device previously displayed the previous learning activity, the user attempted to successfully complete the previous learning activity, wherein M≦N with N being a selected limit of M, wherein M and N are independent integers greater than or equal to 1 and wherein the learning activity and the previous learning activity are associated with the same group in the database; wherein the difficulty level is less than the previous difficulty level if the user did not successfully complete the previous learning activity within N attempts; wherein the difficulty level is greater than the previous difficulty level if the user successfully completed the previous learning activity after M attempts; and wherein the learning activity has not been previously successfully completed by the user.

In a third aspect, the invention pertains to a computing device comprising a processor, a display device, and an accessible storage medium having instruction thereon which, when executed by the processor, cause the computing device to perform a process for delivering to a user a hint adapted to the user's response to a computerized learning activity. The method comprises selecting a hint from a database and displaying the selected hint to the display device after the computing device has received from a user input from one or more input fields displayed to a user along with a graphical representation of learning activity associated with the selected hint, the received input indicating unsuccessful completion of a the displayed learning activity; wherein the database comprises one or more learning activities, an associated successful completion, and, for at least the displayed learning activity, one or more pairs of associated expected hints and expected unsuccessful completions, one or more associated contextual hints and one or more preselected permutations, one ore more associated subject matter hints or a combination thereof; and wherein the selected hint comprises one of the one or more expected hints associated with the displayed learning activity if the received unsuccessful completion is the same as the corresponding expected unsuccessful completion; or wherein the selected hint comprises one of the one ore more contextual hints associated with the displayed learning activity if the database does not comprise an expected unsuccessful completion associated with the displayed learning activity that is the same as the received unsuccessful completion and if a preselected permutation of the received unsuccessful completion is the same as the associated successful completion of the displayed learning activity; or wherein the selected hint comprises one of the one or more subject matter hints if the database does not comprise an expected unsuccessful completion associated with the displayed learning activity that is the same as the received unsuccessful completion and if the there is no preselected permutations of the received unsuccessful completion that is the same as the associated successful completion of the displayed learning activity.

In a fourth aspect, the invention pertains to a method, implemented on a computing device comprising a processor, a display device, and an accessible storage medium, for delivering to a user a hint adapted to the user's response to a computerized learning activity. The method comprises selecting a hint from a database and displaying the selected hint to the display device after the computing device has received from a user input from one or more input fields displayed to a user along with a graphical representation of learning activity associated with the selected hint, the received input indicating unsuccessful completion of a the displayed learning activity; wherein the database comprises one or more learning activities, an associated successful completion, and, for at least the displayed learning activity, one or more pairs of associated expected hints and expected unsuccessful completions, one or more associated contextual hints and one or more preselected permutations, and one ore more associated subject matter hints; and wherein the selected hint comprises one of the one or more expected hints associated with the displayed learning activity if the received unsuccessful completion is the same as the corresponding expected unsuccessful completion; or wherein the selected hint comprises one of the one ore more contextual hints associated with the displayed learning activity if the database does not comprise an expected unsuccessful completion associated with the displayed learning activity that is the same as the received unsuccessful completion and if a preselected permutation of the received unsuccessful completion is the same as the associated successful completion of the displayed learning activity; or wherein the selected hint comprises one of the one or more subject matter hints if the database does not comprise an expected unsuccessful completion associated with the displayed learning activity that is the same as the received unsuccessful completion and if the there is no preselected permutations of the received unsuccessful completion that is the same as the associated successful completion of the displayed learning activity.

### BRIEF DESCRIPTION OF THE DRAWINGS

FIG. 1 is a logical representation of an embodiment of the adaptive learning system architecture.

FIG. 2 is a schematic depiction of one embodiment of a course division scheme.

FIG. 3 is a screen shot of an adaptive learning system showing an instructional video resource comprising an on-screen human speaker.

FIG. 4 is a screen shot of an adaptive learning system showing a different portion of the instruction video resource depicted in FIG. 3.

FIG. 5 is a screen shot of an adaptive learning system showing an instructional document resource.

FIG. 6 is a screen shot of an adaptive learning system showing an identification learning activity.

FIG. 7 is a screen shot of an adaptive learning system showing a drag phrase learning activity.

FIG. 8 is a screen shot of an adaptive learning system showing a matching learning activity.

FIG. 9 is a schematic depiction of an adaptive stack.

FIG. 10 is a flow chart of an embodiment of process flow implemented by an adaptive learning system to support user motivation.

FIG. 11 is a flowchart for an embodiment of a hint selection process.

### DETAILED DESCRIPTION OF THE INVENTION

Described herein are adaptive learning systems and associated automated processes that can help to maintain student motivation which can improve student course completion rate as well as student re-enrollment rate for different courses delivered by the adaptive learning systems and for courses of all types. The teaching systems can be implemented in a networked environment using algorithms designed to improve effectiveness of the learning experience in an efficient delivery package. While there are many facets to promoting student motivation, the concept of personally selected challenge as described herein has been shown to be effective at significantly increasing student motivation, course completion rate and student re-enrollment rate. Additionally, during testing portions of a course, it has been found that student motivation can be further supported by providing a student with guidance and a further opportunity to correctly answer a testing question after the student has already incorrectly answered it. In some embodiments, the adaptive learning systems described herein can further support user motivation though a design approaching integrating student choice.

The adaptive learning systems described herein provide an online learning environment to deliver courses to system users (e.g. students). The adaptive learning systems can deliver courses analogous to traditionally offered elementary school, high school, vocational school and college/university courses, such as art courses, music courses, psychology courses, language courses, mathematics courses, science courses, professional courses (e.g. law and business) and the like. The adaptive learning systems can also deliver courses analogous to technical and paraprofessional courses traditionally offered at technical schools and colleges such as, motor vehicle maintenance and repair courses, heating and cooling maintenance and repair courses, paralegal courses, and the like. In some embodiments, the adaptive learning systems can deliver courses in medical patient education, to increase patient compliance rates, retention and informed consent. Each course can be conceptually divided into units, and each unit into sections which can be used to correspondingly structure the functions of the automated learning system. The sections can comprises course components including learning activities that can be used to test a user's proficiency with the subject matter of the course. The learning activities can be associated with a difficulty level in data store, such that a user has a better chance of correctly completing a learning activity on a first attempt if the learning activity has a lower difficulty level relative to a learning activity with a higher difficulty level. Additionally, as a user completes learning activities, the adaptive learning system can track a user's mastery level of the corresponding subject matter (i.e. a user's proficiency with the subject matter). In some embodiments when a user successfully completes a learning activity, the user's mastery level can be increased and when a user unsuccessfully completes a learning activity, the user's mastery level can remain the same or can be decreased. The properties of mastery level and/or difficulty can be used by the system to implement the concept of personally designed challenge. An intelligent hint engine can be used to further support the automated learning process

A personally selected challenge refers to a process of presenting a user with challenges, e.g., task or questions, that are not too difficult for the user, so that the user does not get frustrated, and are not too simple, so that the user does not get bored, as explained further below. The concept of personally selected challenge in the context of video game environments is discussed in “What Videogames Have to Teach about Learning and Literacy”, by James Paul Gee (second edition, 2007). As used herein, personally selected challenge is adapted to non-game environments. For example, in some systems, learning is explicitly embedded in a game environment, a strategy often referred to as “gamification”. Instead, the adaptive learning systems described herein utilize the underlying concept of personalized challenge to support student motivation in a non-game environment. The systems described herein are not game-like in that students may not adopt fictional roles or personas, may not compete with others, and/or may not be presented with goals or objectives extraneous to the intended underlying studies. In an educational environment, in contrast to a gaming environment, the objectives of the curriculum generally are a multifaceted understanding of a subject matter or complex tasks.

In particular, the adaptive learning systems described herein can automatically find and/or maintain a personally selected level of challenge for each user. By comparing the difficulty level of learning activities not previously seen by a user to the user's mastery level and/or success rate at previous learning activities that were more or less difficult, the adaptive learning system can select learning activities to display to a user to find/maintain a personally selected challenge. By finding the personally selected challenge in an educational environment directed to the learning of coursework, it has been surprising found that student motivation, as well as course completion rate and re-enrollment rate can be significantly increased, and a particular case study is described further below.

Surprisingly, the adaptive learning systems described herein, incorporating the concept of personally selected challenge to support student motivation, have generated outstanding improvements in user course completion rates and user re-registration rates. In particular, experimental studies demonstrated that for a typical college level course, students who used the adaptive learning systems described herein had a 19% higher course completion rate (i.e. achieved a grade of C or better on an A to F scale) and 20% higher re-registration rate (i.e. rate of students enrolling in at least one subsequent course), relative to students who took the on-line course using another educational system not incorporated the design principles described herein.

In some embodiments, user motivation can be further supported by affording a user a plurality of opportunities to successfully complete a learning activity while optionally providing a user with guidance in the form of hints. In some such embodiments, after a user unsuccessfully completes a learning activity, the system can provide the user a hint based upon the user's particular response and, thereafter, can provide the user with another opportunity to successfully complete the same learning activity. Thus, a hint engine can be designed to select hints that further the motivation and learning experiences based on the prior interactions of the system with the user/student.

Thus, the automated personalized adaptive learning systems can provide improved effectiveness of the automated learning process. In some embodiments, the improved effectiveness can be measured objectively through higher course completion rates, and higher re-enrollment rates. The personalized adaptive learning systems can deliver improved learning environment efficiently for cost effective educational process.

Student choice can be a factor that can support user motivation. The adaptive learning system can incorporate student choice by allowing a user to adapt course presentation so that course components can be accessed by a user in a way that is more aligned with the user's preferred learning method. In some embodiments, similar subject matter can be independently presented using different media options. In such an embodiment, a user can select a medium or combinations thereof which the user feels is more aligned with the user's preferred learning method relative to other media. For example, a section of a course can comprise instructional media comprising on one or more video resources, one or more audio resources, one or more document resources and one or more learning activities. To support user motivation the one or more video resource, the one or more audio resource, the one or more document resources and the one or more learning activities can each, collectively, present similar subject matter such that the scope of subject matter presented to a user is essentially the same. A user can then select a single medium (e.g. video, audio, document, or learning activity) or a combination thereof (generally a subset of the total available) to learn the subject matter corresponding to the section without having access other course components. In some embodiments in which a course comprises sections where similar subject matter is independently presented using different media, the adaptive learning system can allow a user to dynamically select media based on the subject matter of a section. For example, in a science course, a user may prefer a video resource to learn the subject matter of a section pertaining to qualitative concepts via, for example, animated graphics so that the user may more easily visualize the principles involved. On the other hand, the user may prefer to learn the subject matter of a section pertaining to computations by way of, for example, a document resource so that the user can absorb the subject matter at the user's desired pace.

### System Architecture

The adaptive learning system can comprise a computing device. As used herein, computing device refers to a device with a processor and accessible storage. A computing device can comprise, for example, personal computers, server computers, main frame computers, computing tablets, set top boxes, mobile telephones, cellular telephones, personal digital assistants (“PDAs”), portable computers, notebook computers, RF readers, laptop computers or any variations thereof now in use or developed in the future. Computing devices may run an operating system, including, but not limited to, variations of the Linux, Unix, Microsoft Disk Operating System (“MS-DOS”), Microsoft Windows, Palm OS, Symbian, Android OS, Apple Mac OS, and/or Apple iOS operating systems. The software instructions for implementing the processes described herein can stored one or more (e.g. distributed) accessible storage devices and can be installed thereon by way of network download or from physical media such as hard disk drive, solid state disk drive, compact disc drive, bluray, disc drive, flash memory, combinations thereof or the like. The system can implement the processes described herein by executing the software instructions with the processor of the computing device having access to the one or more accessible storage devices. In some embodiments, the software instructions can be executed by a plurality of processor corresponding to one or more computing devices for example, in a distributed computing environment in which the execution of software instructions is distributed over one ore more processors.

The resources of the adaptive learning system, such as course component and associated constructs as described below, can be stored on one or more storage devices accessible to the adaptive learning system. The educational programs and any support software can be written using appropriate programming languages for the computing environment and operating systems such as Visual Basic, HTML, or PHP. In embodiments, some or all of the resources can be desirably stored in one or more database structures such as a relational database structure or a document-oriented database structure.

A user can access the adaptive learning system from the user's computing device or devices through a network (e.g. internet or intranet). When requested by the user, the adaptive learning system can deliver system resources through the network so that it is displayed to a display device connected to the user's computing device. In some embodiments, the computing device executing the software instructions can be the same as the user's computing device and the system can display resources to a display device associated with the computing device executing the software instructions. FIG. 1 shows a logical representation of the adaptive learning system architecture of the present invention in one possible configuration. Because the representation is logical rather than physical, those skilled in the art will appreciate the physical implementation of the adaptive system may take the form of a variety of different embodiments, including distributed computing devices where different portions of the adaptive learning process are performed by different computing devices. Referring to FIG. 1, accessible storage 118 to server 102 comprises software instructions for executing the adaptive learning process described herein. A user accesses server 102 through one or more of user's computing devices 120 including smart phone 104, desktop 106, and tablet computing device 108, though network internet/intranet connection 116. Server 102 and user's computing devices 120 may be connected to internet/intranet 116, individually, though an ethernet connection, wife connection, Bluetooth® connection or other connection that allows for appropriate communication between server 102 and user's computing devices 120. In some embodiments, server 102 may be at the same physical location (e.g. in the same building or room therein) as a user's computing device. In other embodiments, server 102 may be geographically remote for a user's computing device. For example, server 1 can be located at a facility in a given city and a user can access server 102 at a geographic location at a different city or from a mobile location such as a vehicle, including but not limited to, a bus, a train or an airplane.

### Course Structure and Components

The adaptive learning systems described generally comprise one or more courses that can be delivered to users that desire to learn material related to the course. A course generally comprises one or more course components that can be organized within the system to provide for effective and efficient instruction and testing for the course subject matter. The adaptive learning system can provide instruction and testing by displaying course components to a user. To significantly simplify the discussion, course components or similar reference to portions of a course refers to the physical manifestation stored in computer memory or storage, the logical structure that provides for the programming of the material and/or the displayed version based on the other versions that is presented to a student, instructor or other individual through a display associated with the educational system, and a person of ordinary skill in the art will be able to understand which manifestation is referred to in the particular context. The course components can comprises instructional components as well as testing components. In some embodiments, the adaptive learning system can dynamically select testing course components to display to a user to facilitate user motivation by, for example, adjusting the difficulty level of the testing components displayed to a user based upon the user's current mastery level with the subject matter. In some embodiment, the adaptive learning system can provide hints to a user during testing to support user motivation.

The subject matter of the course can be conceptually divided into components analogously to the way a book is divided into chapters and sections. A course can be conceptually divided into one or more units, analogously to the way a book is conceptually divided into chapters. Shown schematically in FIG. 2, course 200 is conceptually divided into a three units 202, 204, 206, analogously to chapters in a book on the subject matter of course 200. Similarly, each unit can be conceptually divided into one or more sections analogously to sections of a book chapter. In the embodiment depicted in FIG. 2, unit 204 comprises sections 208, 210, 212. In theory, a course can be conceptually divided into any number of units and sections. In practice, course division can be effected to help promote student motivation. In some embodiments, a course can be divided such that the resulting sections comprise instructional video resources that have a length that is not too long, so that a user looses interest, but is also not to short, so that a user is not desirably engaged by the subject matter presented therein. In some such embodiments, a course can be divided into sections, each having an instructional video resource having a length between about 2 minutes to about 25 minutes, in further embodiments from about 3 to about 15 minutes and in additional embodiments from about 3 to about 8 minutes. For a typical three-credit college course comprising sections having a single instructional video resource, in some embodiments, a course can comprise between 15 units to about 25 units and about 160 sections to about 220 sections. A person of ordinary skill in the art will recognize additional ranges of video resource lengths, units and sections within the explicitly disclosed ranges are contemplated and within the scope of the disclosure.

The adaptive learning system associates each section with one or more course components stored in the data store. The data store comprises at least two types of course components: instructional resources and learning activities and, in general, each section is associated with at least one instructional resource and at least one learning activity. By way of illustration, section 208 of the embodiment depicted in FIG. 2 comprises two instructional resources 214, 216 and 3 learning activities 218, 220, 222. An instructional resource can provide a user with subject matter instruction corresponding to the section. A learning activity can allow the adaptive learning system to measure a user's mastery of the subject matter corresponding to the section as well as to provide a user with instruction. For example, a learning activity can be an automated testing process that has been adapted to not only test mastery of the subject matter but also drive the learning process itself. Based upon whether a student successful or unsuccessfully completes a learning activity, the user can be guided through dynamically selected learning activities to facilitate efficient learning of subject matter not yet mastered by the user, as well as to stimulate user motivation. In some embodiments, learning activities can also provide a user with subject matter instruction by providing a user with hints to increase the user's chances of successfully completing a learning activity and appropriate integration of the hints can improve subject matter instruction.

By way of example, in one exemplary embodiment of the schematic depiction in FIG. 2, course 200 could be “Introduction to Psychology” and unit 124 could be “Learning” and section 208 could be “Classical Conditioning”. Instructional resources 214, 216 could be a video resource and document resource, providing subject matter instruction directed to classical conditioning and learning activities 218, 220, 222 could provide testing or testing and instruction related to classical conditioning.

An instructional resource is a resource that provides subject matter instruction relating to the corresponding section with which it is associated. Generally, an instructional resource is a selected, but dynamically non-interactive resource. An instructional resource can comprise, for example, a video resource, an audio resource, a document resource or a combination thereof. As used herein, a video resource can refer to a multimedia resource (e.g. a resource comprising a combination of different media such as audio, video, illustration and the like). A video resource, an audio resource, and a document resource can comprise any appropriate computer readable video file, audio file, and document file, respectively, that can be downloaded and/or streamed to a user's computing device to provide instruction on the corresponding subject matter. Desirable instructional resource file formats include, but are not limited to, mp3 files, mp4 files, fly files, way files, pdf files, html files, and the like. FIGS. 3 and 4 are screenshots of different portions of a video resource of a “classical conditioning” section of a “learning” unit of an “introduction to psychology course.” FIG. 5 is a screen shot of a document resource providing instruction also relating to classical conditioning.

In some embodiments, an instructional resource can be specifically designed to promote user motivation. In particular, empirical research has demonstrated that teaching through well developed multimedia formats can provide for effective learning, as discussed in “Multimedia Learning”, Second Edition (2009) by Richard Meyer, incorporated herein by reference. In some embodiments, a video resource can be designed to present a balanced mix of visual and auditory elements to help maintain user interest and provide single points of sensory focus. For example, in some embodiments, a video resource can present a human speaker to humanize the viewing experience, but the on-screen image of the human speaker can be presented infrequently or reduced in size to decrease visual distraction, as shown in FIG. 3, for example. In some embodiments, the amount of on screen text can be limited to a reduced set of terms to reduce visual processing conflicts while still presenting a desirable amount of information to the user. In particular, it has been found that video resources comprising about 25% to about 85% animation with voice over, about 10% to about 55% still photograph (with optional palming and/or zooming) with voice over, and about 5% to 25% on screen speaker, can provide for unexpected improvements in promoting user motivation. A person of ordinary skill in the art will recognize additional ranges of video resource percentages, still photograph percentages, and screen speaker percentages within the explicitly disclosed ranges are contemplated and within the scope of the disclosure.

A learning activity comprises an interactive resource, i.e. a resource that is configured to receive input from a user. A learning activity can comprise a challenge and one or more interactive visual elements that allow a user to input a response(s) to the challenge(s). In some embodiments, a challenge can comprise multiple tasks that can be independently displayed to a user along with interactive visual elements to allow user to input a response to a single task. For example, in some embodiments, a challenge can comprise multiple questions that are sequentially presented to a user and wherein a next question is not displayed until the system has received user input corresponding to the previous question. The data store of the adaptive learning system also comprises at least one correct answer associated with each challenge so that by comparing a user's response to a challenge to the correct answer, the adaptive learning system can determine whether the user correctly or incorrectly completed a challenge and, therefore, successfully or unsuccessfully completed the learning activity.

In some embodiments, the challenge can comprise one or more text-based questions that are displayed to a user and the interactive visual elements can be displayed text input fields configured to a receive a user's answer(s) to the corresponding question(s) in the form of text-based response(s). In additional or alternative embodiments, a challenge can be an instruction or series of instruction to the user to manipulate the interactive visual elements in a prescribed manner to demonstrate proficiency with the subject matter tested. For example, FIG. 6 is a screen shot of a identification learning activity comprising a challenge to the user to “click on the area that shows the conditioned response” and interactive visual elements including illustrations of a flask, dog, and light bulb. In response to a displayed challenge, a user can activate (e.g. by click on the corresponding illustration) on the flask, dog, or light bulb to indicate to the system what the user believes is the correct response to the challenge. As another example, FIG. 7 displays a “drag phrase” learning activity comprising a challenge instructing a user to correctly categorize interactive visual elements comprising highlighted phrases (left portion of figure) by moving them to distinctly labeled interactive visual elements comprising input fields (right portion of figure). FIG. 8 displays a “matching” learning activity” comprising a challenge to a user to match interactive visual elements on the left by moving them to labeled input elements on the right.

In some embodiments, by associating stored difficulty levels with at least some of the learning activities in the data store, the adaptive learning system can dynamically select learning activities to present to the user to provide effective and efficient learning and promote user motivation. A difficulty level is a measure of the difficulty of a given learning activity relative to other learning activities associated with that section. As will be explained in detail below, when requested by a user, an adaptive learning system can, based upon the difficulty of the learning activity and the user's currently level of mastery of the corresponding subject matter, dynamically select and display learning activities in a manner that promotes user motivation. In some embodiments in which a section is associated with a plurality of learning activities, each learning activity can have a distinct difficulty level. In some embodiments in which a section is associated with a plurality of learning activities having associated difficulty levels, one or more learning activities can have a difficulty level that is different from any other learning activity. In some embodiments in which a section is associated with a plurality of learning activities having associated difficulty levels, one or more learning activities can have a difficulty level that is the same as one or more other learning activities. In some embodiments, a difficulty level can be initially set, for example, by a subject matter expert, typically an academic with a terminal degree in the corresponding subject matter, and relevant reaching experience, based upon an expert's judgment or experience. In some embodiments, the difficulty level can be further refined by the system based upon the demonstrated ability of users to successfully complete the associated learning activity.

In some embodiments, a difficulty level can be a measure of the likelihood that a user will successfully complete a learning activity on or before Nth attempt (“Nth attempt success rate”). The adaptive learning system can calculate (and store) the Nth attempt success rate as the average Nth attempt success rate of other user's who have attempted to successfully complete the same learning activity. N can be chosen such that it reasonably reflects a level of difficulty (e.g. N can be chosen to be sufficiently small so that it helps to guard against accumulating results based upon repeated guessing and desirably large so that it reflects a broader range of abilities of other users). N can be 1, 2, 3, 4, 5, 6, 7, 8, 9, 10 or higher, corresponding to the 1st attempt success rate, the 2nd attempt success rate, the 3d attempt success rate, and so on. In other embodiments, a difficulty level can also be the average activity level of a student that gets it right on the first try.

The difficulty levels associated with learning activities stored in the data store can be updated continuously or discontinuously. In some embodiments, a difficulty level is updated with a user's first attempt success rate as soon as the user submits a response to the corresponding challenge. In other embodiments, wherein the difficulty level is based a subsequent attempt rate, the difficulty level is updated after the user submits a response to the corresponding challenge corresponding to the subsequent attempt. In other embodiments, first attempt success rates for a learning activity are collected over a plurality of users prior to updating the difficulty level. In embodiments in which the difficulty level is not based on the average first attempt success rate, the difficulty level can be updated when the user's response can provide a corresponding measure of the difficulty level. For example, if the difficulty level is based on the average second attempt success rate, after the user successfully or unsuccessfully completes a learning activity on the second attempt, the difficulty level of the learning activity can be correspondingly updated.

To improve both process and learning efficiency, learning activities associated with a section can be stored within the system as an adaptive stack. In such embodiments, the learning activities associated with a section are rank-ordered by their respectively difficulty level. In embodiments comprising a section associated with a plurality of learning activities, learning activities having the same difficulty level can be assigned the same rank. FIG. 9 shows a schematic representation of an embodiment of an adaptive stack. Referring to the figure, a unit comprises sections 902, 904, 906. Section 904 is associated with 9 learning activities, A₁-A₉ organized in adaptive stack 908. Adaptive stack 908 comprises 6 ranks, 910, 912, 914, 916, 918, 920, with rank 910 associated with the highest difficulty level and rank 920 associated with lowest difficulty level. In the embodiment depicted in FIG. 9, the 6 learning activities are distributed over the ranks, reflecting the hierarchy of learning activity difficulty. Learning activities sharing the same rank are associated with the same difficulty level. In some embodiments, each rank can correspond to a unique bin defined on a distinct, non-overlapping interval in the range of difficulty levels spanned by the learning activities and the learning activities can be placed in the bins according the to which bin bounds the value of the difficulty level associated with the learning activity. For example, if the difficulties levels of learning activities associated with a section span the range [0,5], an adaptive stack can have 5 ranks associated with difficulty levels intervals [0,1), [1,2), [2,3), [3,4) and [4,5] and learning activity having a difficulty level of 4.5 would have a rank associated with the interval [4,5]. The interval notation used follows mathematical convention where a bracket denotes the endpoint is included in the interval and a parenthesis denotes the endpoint is excluded from the interval. For example, the interval [0,1) includes all numbers greater than or equal to 0 and less than 1. In the previous example, the rank associated with the interval [4,5] would be considered the highest rank because it is associated with the highest difficulty level interval and the rank associated with the interval [0,1) would be considered the lowest rank because it is associated with the lowest difficulty level interval. As is discussed in detail below, an adaptive stack can desirably increase the efficiency of course adaptation by reducing the problem of finding a learning activity with a greater or lesser difficulty to a identifying the next incrementally higher or lowest, respectively, rank and the associated learning activities.

In some embodiments, the data store of the adaptive learning system can comprise one or more hints that are associated with one or more learning activities to further promote user motivation as well as to provide subject matter instruction. A hint can comprise and instruction to the user that is designed to improve the user's chance of successfully completing a learning activity and which can be displayed to a user after the user has, on a previous attempt, unsuccessfully completing the same learning activity.

A hint can comprise an expected hint, a contextual hint, or a subject matter hint. An expected hint is a hint and is associated with an expected response in the data store. The expected hint is a hint designed around the specific deficiency of the expected response such that if a user's response matches the expected response, the expected hint can be particularly effective in increases a user's chance of successfully completing the learning activity on the subsequent attempt. As such, in some embodiments, the system can be designed to accommodate common incorrect answers and can have suitable hints prepared to increase a user's chance of successful completing a learning activity on a subsequent attempt. For example, for a learning activity presenting a challenge requiring a text response, the system can compare the user's input text with the text of the expected responses associated with the expected hints of the learning activity and can display a hint corresponding to a particular expected response where the expected response is the same as the user input. As another example, in a matching or dragging learning activities as described above, an expected response can be an expected incorrect ordering of visual elements in the input fields and if the system determines the user's response matches an expected incorrect ordering, the system can display the expected hint associated with matching expected incorrect ordering.

A contextual hint is hint selected by altering the user response in a pre-determined way to determine whether the user's response can be transformed into the correct response. A contextual hint can be associated with one or more transformations in the data store. The system can perform the transformations associated with each contextual hint and if a transformation causes the user's response to match the correct response, the system can display to the user the contextual hint associated with that transformation. For example, in embodiments wherein a user's response to a learning activity challenge is a text response, the transformation can comprise correcting the spelling of the text response and, if spelling correction makes the user's response match the correct response, the system can display a hint to the user comprising an instruction to correct the spelling of the user's response. In additional or alternative embodiments where a user's response to a learning activity challenge is a text response, the transformation can comprise concatenating the user's response to the first N characters of the response and if the first N characters match the first N characters of the correct response, displaying a hint to the user to check the spelling of the user's response, where N can be any integer from max(1, T−1), where T is the total number of characters in the response. In some embodiments wherein a learning activity comprises a matching or dragging learning activity, the transformation can comprise permutations of two or more entries and if any such permutations result in the response matching the associated correct response, the system can display a hint comprising a suggesting at least one of the one or more permutations leading to a correct answer to the user. In some such embodiments comprising an ordering learning activity, if the transformation comprises swapping the entries in two input fields and the transformation results in the user's response matching the correct response, the system can display a hint comprising an instruction to swap the entries in the those input field or to identify to the user at least one user input which is not in the correct order. In further embodiments comprising a dragging or ordering activity, the adaptive learning system can comprise concatenating the user's response to a first/top entry in an ordered list and if the first/top entry does not match with the associated corrected response, the system display a hint comprising an instruction to the user that the first/top entry is incorrect.

A subject matter hint is a hint that links the subject matter of the learning activity to the instructional resources. A subject matter hint comprises an identifier that identifies an instructional resource or a portion thereof in the data store. Each identifier identifies an instructional resource or portion thereof that provides instruction covering the subject matter of the learning activity associated the subject matter hint. In some embodiments, after receiving an incorrect response to a learning activity challenge, the system can display one or more subject matter hints to a user comprising an instruction to the user to study the instructional resources associated with identifier. In some embodiments, the identifier can comprise a links that a user can follow to cause the system to display the corresponding instructional resource to the user. In some embodiments, the link can comprise a link to a specific portion of an instructional resource specifically covering the subject matter of the section associated with the learning activity. For example, in some embodiments, the link opens a video resource to a time different from the start time of the video resource presenting subject matter associated with the learning activity. In other embodiments, the link can open a document to display a specific portion of the document presenting the subject matter instruction associated with the learning activity. If the system comprises hints of multiple types, a particular learning activity can invoke a particular type of hint, or the system can select a type of hint, e.g., an expected hint, a contextual hint or a subject matter hint, based on the users response to the learning activity.

In some embodiments, the data store of an adaptive learning system can comprise one or more mastery levels associated with a user for different course components, e.g., units and/or sections, and/or for different courses. A mastery level is a measure of a user's understanding of the subject matter presented in a respective course, a unit, and/or a section. In some embodiments, an adaptive learning system can define and track a plurality of user mastery levels for a course, each mastery level measuring a user's understanding of the subject matter of the course, of a unit, or of a section. In one embodiment, a mastery level can be specified using a point system, where a point is added to the user's master level every time a user completes an achievement. In some embodiments, an achievement can be the completion of a learning activity, a section, or a unit, where the mastery level is defined on a section, unity or course level, respectively. In some embodiments, a user achieves mastery (i.e. achieves a desirable level of understanding of the subject matter) when the user's mastery level has reached a target value. For example, where a point system is used, the system can determine a user has reached mastery when the user's mastery level has achieved a target value (i.e. when the user has accumulated a target number of points). In some embodiments in which a point system is used. For example, in some embodiments, mastery can be defined on the interval [0,100] where a value of 100 corresponds to complete mastery and 0 reflects that a user has not successfully completed any achievements. As a user successfully completes achievements, the user's mastery level is increased until it reaches a value of 100, at which point, the system determines that the user as achieved mastery of the corresponding subject matter. In some embodiments, the amount of mastery points that are added to a user's mastery level can be different for different achievements. For example, where an achievement corresponds to successfully completion of a learning activity, a greater number of points can be added to a user's mastery level for learning activities that have a higher difficulty level relative to learning activities that have a lower difficulty level.

### Information Flow

Generally, to access the adaptive learning system, a user logs into the system from a user's computing device, desirably, but not necessarily, through a web browser executed on the user's computing device. The login can require authentication of the user, e.g., with a password and/or digital certificate, and can provide user privileges based upon the course or courses for which the user is registered. After login, the system can display a course selection screen to the user, if the user is registered for more than one course. After selecting a course, or if the user is only registered for a single certification course, the system can display a home screen for the corresponding course where the user can access the corresponding course components. From the home screen, a user can access different units and sections by following displayed links. When a user follows a link for a section, the system can display a section welcome screen to the user from which the user can select any of the instructional resources and learning activities associated with the section. When a user follows the link to the learning activities, the system can selecting one or more learning activities to display to the user.

As previously mentioned, the adaptive learning systems described herein can dynamically adapt the selection of the learning activities to display to a user based upon a user's performance (e.g. successfully or unsuccessfully completion) on previous learning activities associated with the same section. FIG. 10 shows an embodiment of a process flow for selecting learning activities to promote user motivation. Referring to the figure, the process starts at 1002 where a learning activity is displayed to a user. In some embodiments, where a user is accessing the learning activities associated with a section for the first time, the system can choose to display a preselected learning activity to the user. In some embodiments, the preselected learning activity can be a learning activity associated with a lowest difficulty. In some embodiments, the learning activity can be dynamically selected based upon the user's past performance on other sections.

At 1004, the system receives a user's response to the learning activity challenge and determines if the user's response to the challenge was correct (i.e. if the user successfully completed the learning activity) at 1006. If the system determines the user successfully completed the learning activity, the processes continues to 1008 where the system determines if the user has achieved mastery of the subject matter corresponding to the section, including the results of the successfully completed challenged at 1006. If the user has achieved mastery, the system so informs the user and the display the dashboard to the user at 1010. If the user has not achieved mastery, the system selects a new learning activity associated with the section at 1012 and displays the learning activity of the user at 1002.

If the system determines the user did not successfully complete the learning activity at 1006, the system calculates the number of times the user has unsuccessfully completed the learning activity at step 1014. If the number of unsuccessful attempts is equal to an attempt limit, the process proceeds to step 1016. The attempt limit can be selected to balance supporting user motivation with testing accuracy (e.g. reduce the probability that the user can successfully complete the learning activity by chance or process of elimination). In some embodiments, the attempt limit can be 1, 2, 3, 4, 5 6, 7, 8, 9, 10 or more or more. At step 1014, the system determines if there are additional learning activities associated with the section which have not been presented to the user. If there are additional learning activities that have not been presented to the user, the process continues to 1012. If there are no learning activities that have not been presented to the user the process continues to 1020. If the number of unsuccessful attempts is less than an attempt limit, the system can use a hint engine to select appropriate hints to display to the user at 1018, as explained in detail below. After displaying an appropriate hint, the system can then redisplay the originally displayed learning activity to the user at 1002.

At 1020, the adaptive learning system implements a process where the potential pool of learning activities to be presented to a user is selected from those activities the user has not successfully completed within the attempt limit. Then activities are selected from that pool as is performed at 1012. If mastery is not achieved before the learning activity pool is exhausted, then the pool is again selected from those activities the user has still not successfully completed, and the process is repeated. In one embodiment, at 1020, the systems restricts the potential choice of learning activities to present to a user to learning activities that a user has not yet successfully completed and decreases the attempt limit by one attempt for all of those activities. The process then continues to step 1002 wherein the selected previously presented learning activity is presented to the user.

### Adaptive Selection of Learning Activities

With respect to the selection of new learning activities at 1012, the adaptive leaning systems described herein can adapt the selection of new learning activities to promote user motivation. Generally, the selection of a new learning activity is based upon the difficulty levels associated with the learning activities as well as on the user's success rate in successfully completing learning activities. In some embodiments, where a user successfully completes a previous learning activity, the system can select a next most difficult learning activity that the system has not previously presented to the user. And, where a user unsuccessfully completes a previous learning activity, the system can select a next least difficult learning activity that the system has not previously presented to the user. In some embodiments, the selection of a new learning activity can comprise selecting a learning activity having a difficulty level that is expect to help keep the user's success rate within a target range.

In some embodiments, selecting a new learning activity can comprise selecting an incrementally more difficult learning activity or an incrementally less difficult learning activity. Such embodiments can be desirably implemented using an adaptive stack, as discussed above. When a user successfully completes a learning activity in a stack, the system can present to the user an incrementally more difficult learning activity, which has not previously been presented to the user, from the stack. The selection can comprise interrogating the next higher rank (relative to the rank associated with the correctly completed learning activity) in the stack and determining if the rank is associated with any learning activities that have not been presented to the user. If there are, the system can select a learning activity, e.g., randomly or with a particular algorithm, to display to the user (or if there is only one such learning activity, displaying that learning activity to the user). If there are no such activities, the system can continued to interrogate subsequently higher ranks to determine if there are learning activities associated with the corresponding ranks that have not previously been displayed to the user and can display those learning activities. While the interrogation of higher ranks could be performed in any order, it is desirable to interrogate the ranks from the next higher rank to the highest rank to increase process efficiency. Analogously, when a user fails to successfully complete a learning activity within the attempt limit, the system can present to the user an incrementally less difficult learning activity, which has not previously been presented to the user, from the stack. The selection can comprise interrogating the next lower rank (relative to the rank associated with the learning activity the user failed to successfully complete) in the stack and determining if the rank is associated with any learning activities that have not been presented to the user. If there are, the system can select a learning activity, e.g., randomly or with a particular algorithm, to display to the user (or if there is only one such learning activity, displaying that learning activity to the user). If there are no such activities, the system can continue to interrogate subsequently lower ranks to determine if there are learning activities associated with the corresponding ranks that have not previously been displayed to the user and can display those learning activities. While the interrogation of lower ranks could be performed in any order, it is desirable to interrogate the ranks from the next lower rank to the lowest rank to increase process efficiency.

In some embodiments, the selection of new learning activities can comprise selecting learning activities help to maintain a user's success rate within a predetermined range in order to promote user motivation. Such embodiments can be desirably implemented using an adaptive stack, as discussed above. In some such embodiments, a user's probability of success for each available learning activity in a stack can be determined and an expected average success rate can be determined for each available learning activity in the stack not yet presented to the user, were that learning activity to be presented next to the user. The learning activity the system selects to present to the user can be the one that produces an expectation value within a target range, or one that is closest to the target range if none are within the target range.

In some embodiments, to determine a user's probability of success, an averaging interval for success can be selected to define a user's success rate. For example, a user's success rate can be a user's first attempt success rate as determined from the preceding N distinct learning activities presented to the user, where N can be any reasonable integer selected to provide a reasonable measure of the user's current success rate, for example, any integer between 1 about 50, or N can be all of the previous learning activities for a section, unit or course as desired. The user's probability of success for a given learning activity in a stack can be determined by tracking the user's success rate for other learning activities previously presented to the user or a selected subset thereof, from the same stack or from a different stack. Desirably, each of the other selected learning activities for evaluating a probability of success can be associated with a rank that corresponds to a difficulty that overlaps with the difficulty range associated with the rank of the given learning activity (i.e. a similar difficulty level). In other embodiments, a user's probability of success for each learning activity not yet presented to a user can be taken as the average success rate of all users for each of the learning activities not yet presented to a user. In further embodiments a user's probability of success for each learning activity not yet presented to a user can be taken as the average success rate of all users, having a similar master level to that of the user, for each of the learning activities not yet presented to the user.

In some embodiments, the expected average success rate can be defined as: R_{n,ex}=N_{c}/(N+1)+Rₙ/(N+1), wherein N_{c} denotes the user's number of successful responses for the previous N learning activities presented to the user, n denotes an activity from a stack from which the next question to be presented is selected, Rₙ denotes the user's success rate for learning activities having a similar difficulty level as that of a learning activity in the stack, and R_{n,ex} is the user's expected success rate following learning activity n. At the beginning of a course, Rₙ can be selected at a reasonable arbitrary level, such as 50. For example, if the user previously completed a learning activity from stack S₁, and the user's number of successful responses determined from the last N=3 distinct learning activities presented to the user is 2 and the user's success rate for learning activities have a difficulty level that is similar to learning activity n is 80%, the user's expected success rate can be calculated as 2/4+80%/4=70%. The user's expected success rate on other learning activities not previously presented to the user can be similarly calculated. After the user's expected success rate on all activities in a section that have not been previously presented to a user have been calculated, a learning activity having an expected success rate within a predetermined range can then be selected. In some embodiments, the predetermined range is between about 40% to about 95%; in other embodiments, from about 60% and about 80%, in other embodiments between about 65% and about 75% and in further embodiments, between 68% and about 72%. A person of ordinary skill in the art will recognize additional ranges of predetermined rages within the explicitly disclosed ranges are contemplated and within the scope of the disclosure.

### Hint Engine

The adaptive learning systems described herein can desirably incorporate a hint engine to support user motivation during completion of learning activities. Additionally, the hint engine can allow for learning activity resource to provide subject matter instruction, similar to instructional resources. The hint engine can be used to support user motivation in embodiments where the system permits a user a plurality of attempts to successfully complete a learning activity. After at least one successful attempt at completing a learning activity, the system can display a hint to a user, the hint comprising information designed to increase a user's chance of successfully completing the corresponding learning activity on a subsequent attempt. The design of particular hints in the context of learning activities is described above.

To promote user motivation, the adaptive learning systems described herein can select hints using a hierarchal approach leveraging a hint stack. In particular, the adaptive learning system can have stored in a data store a hint stack for each learning activity having one or more hints. The hint stack can comprise hint identifiers, identifying hints associated with a learning activity, the identifiers being rank ordered in the hint stack with expected hints having the highest rank, contextual hints having the next highest rank and subject matter hints having the lowest rank. FIG. 11 shows a flowchart for an embodiment of a hint selection process 1018 comprising a hierarchal hint selection approach using hint stacks. At 1102, the system determines if the user's response to the challenge matches an expected response and, if so, the system displays the corresponding hint to the user at 1104 and then returns to 1002. If not, the system determines if any predetermined manipulations of the user response transform the user's response into the associated correct response and, if so, the corresponding hint is displayed to the user at 1104 and then returns to 1002. If not, the system determines if the hint stack comprises any identifiers for a subject matter hint corresponding to the learning activity at 1106 and, if so, the system displays to the corresponding hint at 1140 and then ultimately returns to 1002. If not, the system can inform the user the user's response to the challenge was incorrect and can display the learning activity again at 1002.

The specific embodiments above are intended to be illustrative and not limiting. Additional embodiments are within the broad concepts described herein. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein.

What is claimed:

1. A computing device comprising a processor, a display device, and an accessible storage medium having instruction thereon which, when executed by the processor, cause the computing device to perform a method for dynamically selecting a learning activity to deliver to a user to support user motivation comprising, the method comprising:
selecting a learning activity having a difficulty level from a database comprising a plurality of learning activities and associated difficulty levels, the learning activities logically associated into groups in the database wherein each group corresponds to a section of a course, and displaying the learning activity to a user via the display device, wherein a learning activity comprises a challenge and one or more user input fields configured to receive input collectively indicating completion of the learning activity and wherein the difficulty level is a measure of the probability that the user will successfully complete the learning activity;
wherein the computing device previously displayed to a user M times, a previous learning activity having a previous difficulty level selected from database and wherein each time the computing device previously displayed the previous learning activity, the user attempted to successfully complete the previous learning activity, wherein M≦N with N being a selected limiting value of M, wherein M and N are integers greater than or equal to 1 and wherein the learning activity and the previous learning activity are associated with the same group in the database;
wherein the difficulty level is less than the previous difficulty level if the user did not successfully complete the previous learning activity within N attempts;
wherein the difficulty level is greater than the previous difficulty level if the user successfully completed the previous learning activity after M attempts; and
wherein the learning activity has not been previously successfully completed by the user.

2. The computing device of claim 1 wherein the selecting comprises interrogating the database to identify learning activities associated with the same group as previous learning activity and choosing for display to a user a learning activity not previously presented to a user and having a difficulty level that is determined to maintain a user's success rate within a target range.

3. The computing device of claim 2 wherein the target range is between about 40% and about 95%.

4. The computing device of claim 3 wherein the target range is between about 60% and about 80%.

5. The computing device of claim 1 wherein each group comprises a rank-ordered list of learning activities comprising a plurality of ranks, wherein each rank corresponds to a distinct, non-overlapping interval in the range of difficulty levels spanned by the learning activities in the group and wherein each learning activity is associated with a rank corresponding to the interval bounding the corresponding difficulty level.

6. The computing device of claim 5 wherein the user failed to successfully complete the previous learning activity within N attempts and wherein the selecting the learning activity comprises determining from the rank-ordered list corresponding to the group associated with the previous learning activity a learning activity that has not been previously displayed to the user and that is associated with a lower rank than the rank associated with the previous learning activity, but that is the same as or greater than the rank of any other learning activity of the same group that has not been previously presented to the user.

7. The computing device of claim 5 wherein the user successfully completed the previous learning activity on the user's Mth attempt and wherein the selecting the learning activity comprises determining from the rank-ordered list corresponding to the group associated with the previous learning activity a learning activity that has not been previously displayed to the user and that is associated with a lower rank than the rank associated with the previous learning activity but that is the same as or greater than the rank of any other learning activity of the same group that has not been previously presented to the user.

8. The computing device of claim 1 wherein the probability that the user will successfully complete the learning activity comprises the probability that the user will successfully complete the learning activity prior to or on the user's Nth attempt.

9. The computing device of claim 10 wherein the probability that the user will successfully will successfully complete the learning activity prior to or on the user's Nth attempt is related to the average Nth attempt success rate for other users who have attempted to complete the learning activity.

10. The computing device of claim 9 wherein N=3.

11. The computing device of claim 9 further wherein the user successfully responds to the learning activity on the user's Mth attempt and further comprising updating the difficulty level of the learning activity to reflect the user successfully completed the learning activity.

12. A method, implemented on computing device comprising a processor, a display device and accessible memory, for dynamically selecting a learning activity to deliver to a user to support user motivation comprising:
selecting a learning activity having a difficulty level from a database comprising a plurality of learning activities and associated difficulty levels, the learning activities logically associated into groups in the database wherein each group corresponds to a section of a course, and displaying the learning activity to a user via the display device, wherein a learning activity comprises a challenge and one or more user input fields configured to receive input collectively indicating completion of the learning activity and wherein the difficulty level is a measure of the probability that the user will successfully complete the learning activity;
wherein the computing device previously displayed to a user M times, a previous learning activity having a previous difficulty level selected from database and wherein each time the computing device previously displayed the previous learning activity, the user attempted to successfully complete the previous learning activity, wherein M≦N with N being a selected limit of M, wherein M and N are independent integers greater than or equal to 1 and wherein the learning activity and the previous learning activity are associated with the same group in the database;
wherein the difficulty level is less than the previous difficulty level if the user did not successfully complete the previous learning activity within N attempts;
wherein the difficulty level is greater than the previous difficulty level if the user successfully completed the previous learning activity after M attempts; and
wherein the learning activity has not been previously successfully completed by the user.

13. A computing device comprising a processor, a display device, and an accessible storage medium having instruction thereon which, when executed by the processor, cause the computing device to perform a process for delivering to a user a hint adapted to the user's response to a computerized learning activity, the method comprising:
selecting a hint from a database and displaying the selected hint to the display device after the computing device has received from a user input from one or more input fields displayed to a user along with a graphical representation of learning activity associated with the selected hint, the received input indicating unsuccessful completion of a the displayed learning activity;
wherein the database comprises one or more learning activities, an associated successful completion, and, for at least the displayed learning activity, one or more pairs of associated expected hints and expected unsuccessful completions, one or more associated contextual hints and one or more preselected permutations, one ore more associated subject matter hints or a combination thereof; and
wherein the selected hint comprises one of the one or more expected hints associated with the displayed learning activity if the received unsuccessful completion is the same as the corresponding expected unsuccessful completion; or
wherein the selected hint comprises one of the one ore more contextual hints associated with the displayed learning activity if the database does not comprise an expected unsuccessful completion associated with the displayed learning activity that is the same as the received unsuccessful completion and if a preselected permutation of the received unsuccessful completion is the same as the associated successful completion of the displayed learning activity; or
wherein the selected hint comprises one of the one or more subject matter hints if the database does not comprise an expected unsuccessful completion associated with the displayed learning activity that is the same as the received unsuccessful completion and if the there is no preselected permutations of the received unsuccessful completion that is the same as the associated successful completion of the displayed learning activity.

14. The computing device of claim 13, wherein the one or more input fields comprises a plurality of input fields and the preselected permutation comprises transposing the values in any two of the filed.

15. The computing device of claim 14 wherein the contextual hint comprises an instruction to perform the preselected permutation.

16. The computing device of claim 13 wherein the one ore more input fields comprise as least one text input field and wherein the preselected permutation comprises correcting the spelling on the text received in the at least one text input field.

17. The computing device of claim 16 wherein the contextual hint comprises and instruction to correct the spelling at least on text input field.

18. The computing device of claim 13 wherein the subject matter hint comprises a suggestion to the user to study the subject matter of the associated learning activity.

19. The computing device of claim 18 wherein the suggestion is a link to subject matter resources directed to the subject matter of the associated learning activity and wherein following the link causes the processor to display the subject matter resource.

20. The computing device of claim 19 wherein the subject matter resource is selected from the group consisting of a video presentation, a document, an interactive presentation, and an audio presentation.

21. The computing device of claim 13 wherein the database comprises one or more expected hints, one or more contextual hints and one or more subject matter hints.

22. A method, implemented on a computing device comprising a processor, a display device, and an accessible storage medium, for delivering to a user a hint adapted to the user's response to a computerized learning activity, the method comprising:
selecting a hint from a database and displaying the selected hint to the display device after the computing device has received from a user input from one or more input fields displayed to a user along with a graphical representation of learning activity associated with the selected hint, the received input indicating unsuccessful completion of a the displayed learning activity;
wherein the database comprises one or more learning activities, an associated successful completion, and, for at least the displayed learning activity, one or more pairs of associated expected hints and expected unsuccessful completions, one or more associated contextual hints and one or more preselected permutations, and one ore more associated subject matter hints; and
wherein the selected hint comprises one of the one or more expected hints associated with the displayed learning activity if the received unsuccessful completion is the same as the corresponding expected unsuccessful completion; or
wherein the selected hint comprises one of the one ore more contextual hints associated with the displayed learning activity if the database does not comprise an expected unsuccessful completion associated with the displayed learning activity that is the same as the received unsuccessful completion and if a preselected permutation of the received unsuccessful completion is the same as the associated successful completion of the displayed learning activity; or
wherein the selected hint comprises one of the one or more subject matter hints if the database does not comprise an expected unsuccessful completion associated with the displayed learning activity that is the same as the received unsuccessful completion and if the there is no preselected permutations of the received unsuccessful completion that is the same as the associated successful completion of the displayed learning activity.
